(19) United States
(12) Patent Application Publication
(10) Pub. No.: US 2008/0129818 A1
(43) Pub. Date: Jun. 5, 2008

(54) METHODS FOR PRACTICALLY SIMULATNIG COMPACT 3D ENVIRONMENTS FOR DISPLAY IN A WEB BROWSER

(76) Inventor: Jacob James Miller, Sarasota, FL (US)

Correspondence Address: LAW OFFICES OF ERIC KARICH, 2807 ST. MARK DR., MANSFIELD, TX, 76063, US

(21) Appl. No.: 11/971,081

(22) Filed: Jan. 8, 2008

Related U.S. Application Data
(63) Continuation-in-part of application No. 11/056,935, filed on Feb. 11, 2005.
(60) Provisional application No. 60/543,216, filed on Feb. 11, 2004.

(51) Int. Cl. H04N 7/00

(52) U.S. Cl. 348/36; 348/E07.001

(57) ABSTRACT

A method for simulating movement of a user through a remote environment utilizes a still camera with a panoramic lens to capture 360 degree panoramic still images at intervals along a predefined path through the remote environment. A computer system stores the 360 degree panoramic still images and displays a plan view of the remote environment and the predefined path, receives input from the user indicative of a direction of view and a desired location, and displays portions of the 360 degree panoramic still images in a user's view portion of a display screen dependent upon the user input such that the displayed images correspond to the direction of view and the desired location.

### CROSS-REFERENCE TO RELATED APPLICATIONS

This application for a utility patent is a continuation-in-part of a previously filed utility patent, now abandoned, having the application Ser. No. 11/056,935, filed Feb. 11, 2005, which claims the benefit of U.S. Provisional Application No. 60/543,216, filed Feb. 11, 2004.

### BACKGROUND OF THE INVENTION

1. Field of the Invention

This invention relates generally to virtual reality technology, and more particularly to systems and methods for simulating movement of a user through a compact 3D virtual environment for display in a web browser.

2. Description of Related Art

Virtual reality technology is becoming more common, and several methods for capturing and providing virtual reality images to users already exist. In general, the term “virtual reality” refers to a computer simulation of a real or imaginary environment or system that enables a user to perform operations on the simulated system, and shows the effects in real time.

A popular method for capturing images of a real environment to create a virtual reality experience involves capturing a single 360 degree panoramic image of the surroundings, and incorporating the image into a computer model that can be used to produce a simulation that allows a user to view in all directions around that single static point.

Videos can give the illusion of moving forward in space, and 360-degree videos are made using two 185-degree fisheye lenses on either a standard 35 mm film camera or a progressive high definition camcorder. The movies are then digitized and edited using standard post-production processes, techniques, and tools. Once the movie is edited, final IPIX hemispherical processing and encoding is available exclusively from IPIX.

IPIX Movies are made using a commercially available digital camcorder using the miniDV digital video format and a fisheye lens. Raw video is captured and transferred to a computer via a miniDV deck or camera and saved as an audio video interleave (AVI) file. Using proprietary IPIX software, AVI files are converted to either the RealMedia® format (RealNetworks, Inc., Seattle, Wash.) or to an IPIX proprietary format (180-degree/360-degree) for viewing with the RealPlayer® (RealNetworks, Inc., Seattle, Wash.) or IPIX movie viewer, respectively.

A system and method for producing panoramic video has been devised by FXPAL, the research arm of Fuji Xerox (Foote et al., U.S. Published Application 2003/0063133, now U.S. Pat. No. 7,096,428). Systems and methods are disclosed for generating a video for virtual reality wherein the video is both panoramic and spatially indexed. The video system includes a controller, a database including spatial data, and a user interface in which a video is rendered in response to a specified action. The video includes a plurality of images retrieved from the database. Each of the images is panoramic and spatially indexed in accordance with a predetermined position along a virtual path in a virtual environment.

Unfortunately, the video apparatus required by Foote et al. to produce virtual reality videos produces low-quality images limited due to the video nature of the images. Furthermore, the user is moved through the remote environment as the video progresses along the virtual path, without the user being able to halt at desired locations to look around. While this is suitable for certain applications, such as a drive down PCH at sunset, it is not suitable for others, such as remote tours of homes.

The prior art teaches a system and method for generating a panoramic video. However, the prior art does not teach a system and method for generating a series of still images that are panoramic and spatially indexed. The present invention fulfills these needs and provides further related advantages as described in the following summary.

### SUMMARY OF THE INVENTION

The present invention teaches certain benefits in construction and use which give rise to the objectives described below.

The present invention provides a method for simulating movement of a user through a remote environment. The method utilizes a still camera with a panoramic lens. At least one predefined path is defined through the remote environment, and a plurality of intervals are selected along the at least one predefined path. The still camera is positioned at each of the intervals to capture a 360 degree panoramic still image at each interval. A computer system stores the 360 degree panoramic still images and displays a plan view of the remote environment and the predefined path, receives input from the user indicative of a direction of view and a desired location, and displays portions of the 360 degree panoramic still images in a user's view portion of a display screen dependent upon the user input such that the displayed images correspond to the direction of view and the desired location.

A primary objective of the present invention is to provide a method for practically simulating compact 3D environments for display in a web browser, the method having advantages not taught by the prior art.

Another objective is to provide a method that utilizes a still camera that includes a panoramic lens to capture a series of 360 degree panoramic still images at a plurality of intervals along at least one predefined path.

Another objective is to provide a computer system for displaying portions of the still images, responsive to a user's input, to simulate movement through one step at a time through the remote environment.

Another objective is to provide a method for practically simulating compact 3D environments, such as rooms within homes, with limited numbers of images so that the images are quick to download and display.

A further objective is to provide a method that is easily controlled through a web browser.

Other features and advantages of the present invention will become apparent from the following more detailed description, taken in conjunction with the accompanying drawings, which illustrate, by way of example, the principles of the invention.

### BRIEF DESCRIPTION OF THE DRAWING

The accompanying drawings illustrate the present invention. In such drawings:

FIG. 1 is a diagram of one embodiment of a computer system used to carry out various methods for simulating movement of a user through a remote environment;

FIG. 2 is a flowchart of a method for simulating movement of a user through a remote environment;

FIGS. 3A-3E in combination form a flowchart of a method for providing panoramic still images of a remote environment to a user such that the user has the perception of moving through the remote environment;

FIG. 4 is diagram depicting points along multiple paths in a remote environment;

FIG. 5 is a diagram depicting a remote environment wherein multiple parallel paths form a grid network;

FIGS. 6A-6C illustrate a method used to join together edges (i.e., “stitch seams”) of panoramic still images such that the user of the computer system of FIG. 1 has a 360 degree field of view of the remote environment; and

FIG. 7 shows an image displayed on a display screen of a display device of the computer system of FIG. 1.

### DETAILED DESCRIPTION OF THE INVENTION

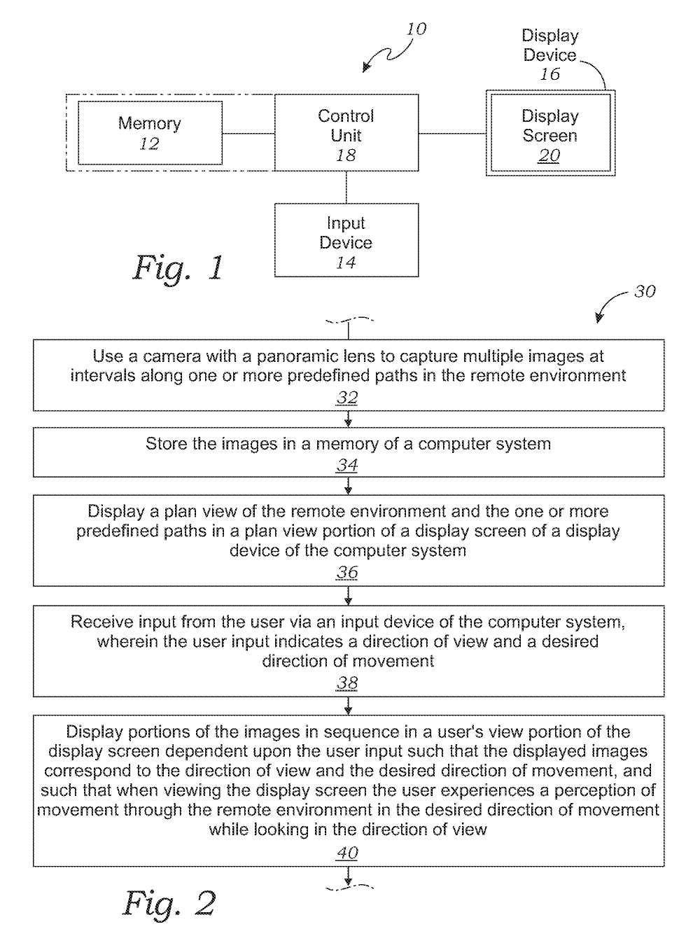

FIG. 1 is a diagram of one embodiment of a computer system 10 used to carry out various methods described below for simulating movement of a user through a remote environment. The remote environment is preferably a compact environment, such as, for example, the interior of a building such as a house, an apartment complex, or a museum.

Alternative methods may be better suited for large outdoor environments such as towns or cities, but the present method is particularly suited for small environments that may be covered with a small number (less than 150) of still images, rather than a large number (10,000 images+) of video images.

In the embodiment of FIG. 1, the computer system 10 includes a memory 12, an input device 14 adapted to receive input from a user of the computer system 10, and a display device 16, all coupled to a control unit 18. The memory 12 may be or include, for example, a hard disk drive, or one or more semiconductor memory devices. As indicated in FIG. 1, the memory 12 may physically located in, and considered a part of, the control unit 18. The input device 14 may be, for example, a pointing device such as a mouse, and/or a keyboard.

In general, the control unit 18 controls the operations of the computer system 10. The control unit 18 stores data in, and retrieves data from, the memory 12, and provides display signals to the display device 16. The display device 16 has a display screen 20. Image data conveyed by the display signals from the control unit 18 determine images displayed on the display screen 20 of the display device 16, and the user can view the images.

FIG. 2 is a flowchart of a method 30 for simulating movement of a user through a remote environment. To aid in the understanding of the invention, the method 30 will be described as being carried out using the computer system 10 of FIG. 1. During a step 32 of the method 30, a still camera with a panoramic lens is used to capturing multiple panoramic still images at intervals along one or more predefined paths in the remote environment.

The panoramic still images may be, for example, 360 degree panoramic still images wherein each image provides a 360 degree view around a corresponding point along the one or more predefined paths. Alternately, the panoramic still images may be pairs of 180 degree panoramic still images, wherein each pair of images provides a 360 degree view around the corresponding point. Each pair of 180 degree panoramic still images may be joined at edges (i.e., stitched together) to form a 360 degree view around the corresponding point.

The panoramic still images are stored the memory 12 the computer system 10 of FIG. 1 during a step 34. During a step 36, a plan view of the remote environment and the one or more predefined paths are displayed in a plan view portion of the display screen 20 of a display device 16 of FIG. 1. Input is received from the user via the input device 14 of FIG. 1 during a step 38, wherein the user input is indicative of a direction of view and a desired location. During a step 40, portions of the images are displayed in sequence in a user's view portion of the display screen 20 of the display device 16 of FIG. 1 dependent upon the user input. The portions of the images are displayed such that the displayed images correspond to the direction of view and the desired location, and such that when viewing the display screen the user experiences a perception of movement through the remote environment.

Importantly, once the user selects the desired location, he or she views the image from the corresponding one of the plurality of intervals, and does not move to other intervals through the remote environment automatically, as with prior art video embodiments. The user may remain at the desired location, and view the image from the selected one of the plurality of intervals, for as long as desired, and rotate the direction of view. The image is of high quality, so the user has a clear view of the entire space.

This system is particular optimal for remote viewing of homes or other properties. In this embodiment, the user does not want to be swept through the space as directed by a video of the home; the user will want to step carefully through the space, looking carefully at the home, retracing steps, looking at different features from different angles, to determine whether they are really interested in the property.

In the preferred embodiment, each image is a 360 degree panoramic still image captured using the 360 degree lens described above. It is critical to the present invention that the images provided are high quality still images rather than video images. While video images are easier to capture in bulk, and are well suited to virtual tours of cities (requiring 10,000+ images), they do not provide the quality and clarity of several linked still images. Each of the 360 degree panoramic still images may be subjected to a correction process wherein flaws caused by the panoramic camera lens, if any, are reduced.

Referring back to FIG. 1, in a preferred embodiment of the computer system 10 the control unit 18 is configured to carry out the steps of 36, 38, and 40 of the method 30 of FIG. 2 under software control. In a preferred embodiment, the software determines coordinates of a visible portion of a first displayed image, and sets a direction variable to either north, south, east, or west.

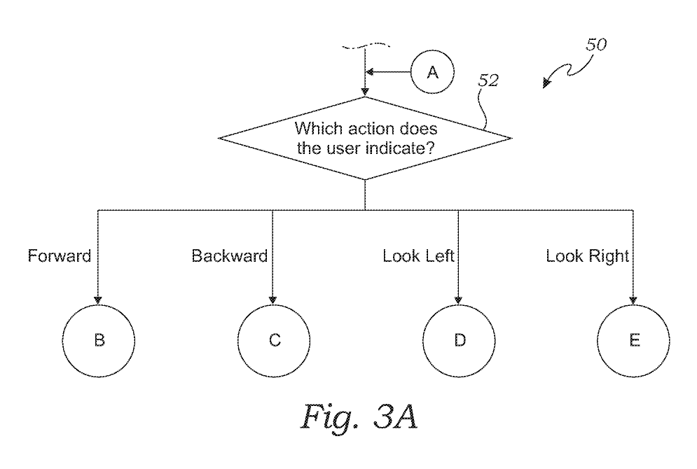

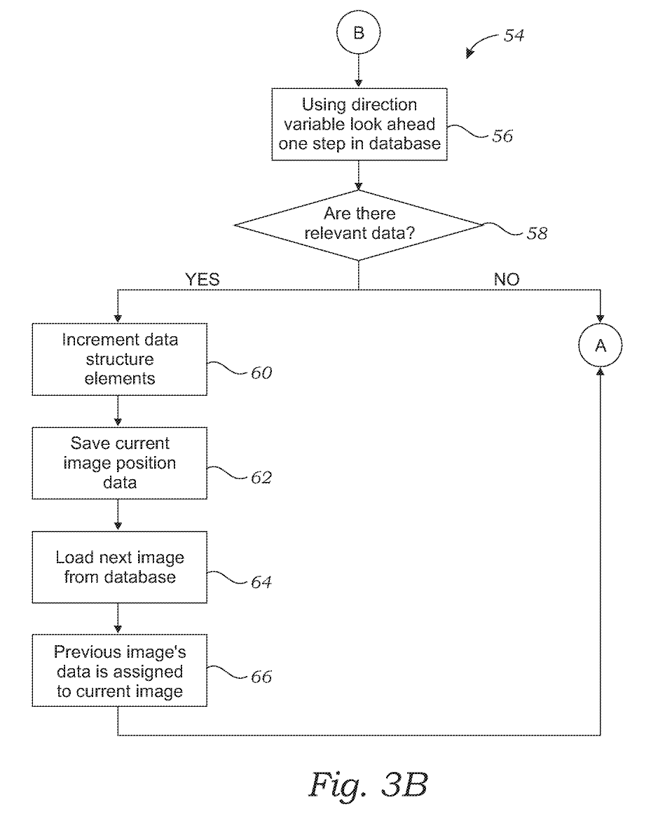

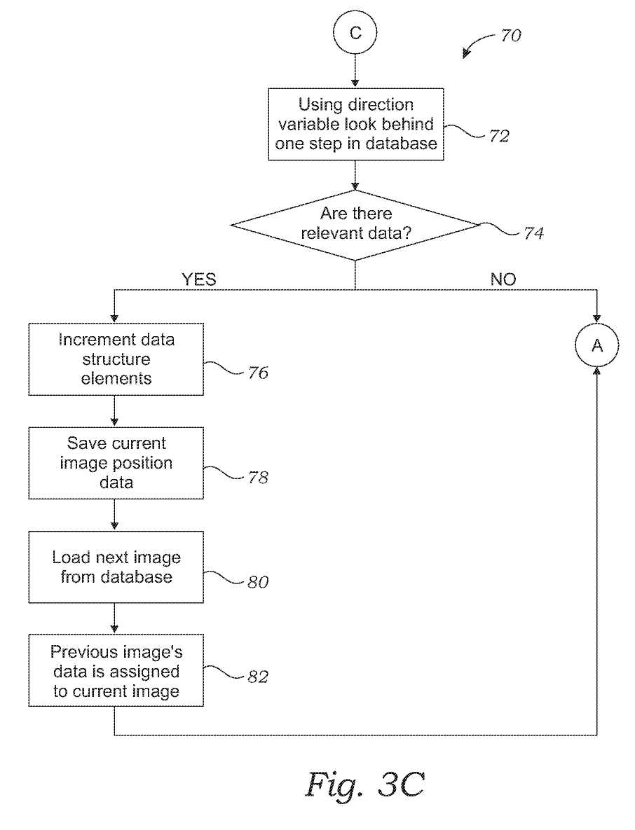

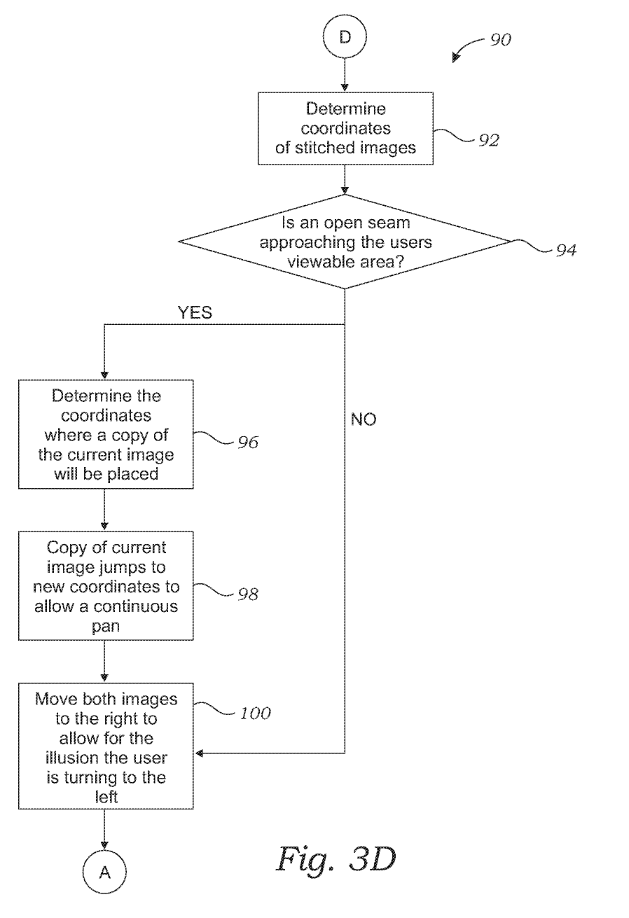

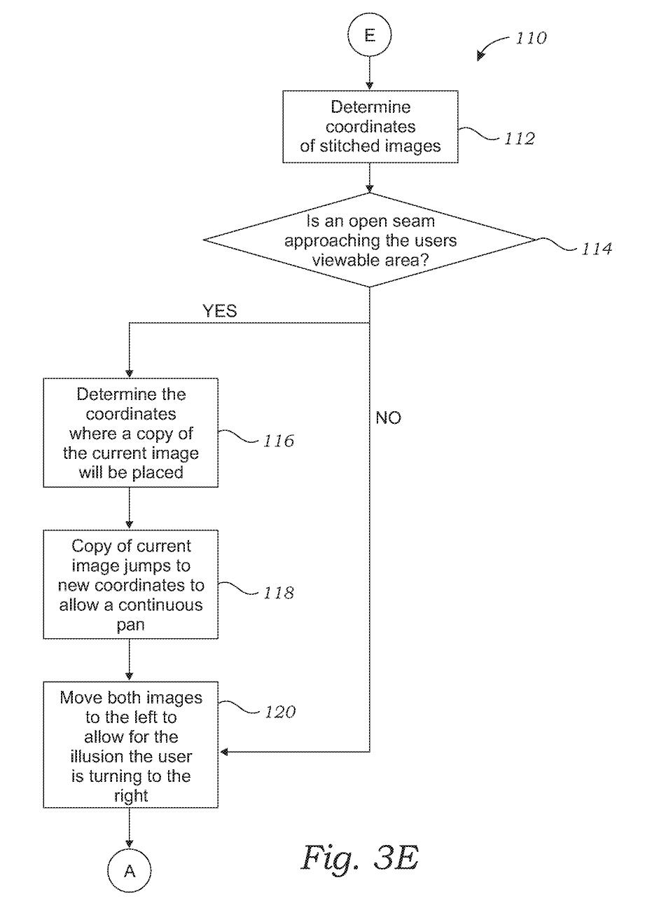

FIGS. 3A-3E in combination form a flowchart of a method 50 for providing images of a remote environment to a user such that the user has the perception of moving through the remote environment. The images are captured (e.g., using a still camera with a panoramic lens) at intervals along one or more predefined paths in the remote environment. To aid in the understanding of the invention, the method 50 will be described as being carried out using the computer system 10 of FIG. 1. The method 50 may be incorporated into the method 30 described above.

While each still image capture requires significantly more time and effort to capture than running a video through the environment, it also offers an opportunity to be more precise and to control the environment to a greater degree. For example, mirrors that may reflect an image of the camera may be moved to prevent such intrusion, as is discussed in greater detail below.

The images are stored in the memory 12 of the computer system 10, and form an image database. The user can move forward or backward along a selected path through the remote environment, and can look to the left or to the right. A step 52 of the method 50 involves waiting for user input indicating move forward, move backward, look to the left, or look to the right. If the user input indicates the user desires to move forward, a move forward routine 54 of FIG. 3B is performed. If the user input indicates the user desires to move backward, a move backward routine 70 of FIG. 3C is performed. If the user input indicates the user desires to look to the left, a look left routine 90 of FIG. 3C is performed. If the user input indicates the user desires to look to the right, a look right routine 110 of FIG. 3D is performed. One performed, the routines return to the step 52.

FIG. 3B is a flowchart of the move forward routine 54 that simulates forward movement of the user along the selected path in the remote environment. During a step 56, the direction variable is used to look ahead one record in the image database. During a decision step 58, a determination is made as to whether there is an image from an image sequence along the selected path that can be displayed. If such an image exists, steps 60, 62, 64, and 66 are performed. During the step 60, data structure elements are incremented. The data related to the current image's position is saved during the step 62. During the step 64, a next image from the image database is loaded. A previous image's position data is assigned to a current image during a step 66.

During the decision step 58, if no image from an image sequence along the selected path can be displayed, the move forward routine 54 returns to the step 52 of FIG. 3A.

FIG. 3C is a flowchart of the move backward routine 70 that simulates movement of the user in a direction opposite a forward direction along the selected path in the remote environment. During a step 72, the direction variable is used to look behind one record in the image database. During a decision step 74, a determination is made as to whether there is an image from an image sequence along the selected path that can be displayed. If such an image exists, steps 76, 78, 80, and 82 are performed. During the step 76, data structure elements are incremented. The data related to the current image's position is saved during the step 78. During the step 80, a next image from the image database is loaded. A previous image's position data is assigned to a current image during the step 82.

During the decision step 74, if no image from an image sequence along the selected path can be displayed, the move backward routine 70 returns to the step 52 of FIG. 3A.

FIG. 3D is a flowchart of the look left routine 90 that allows the user to look left in the remote environment. During a step 92, coordinates of two images that must be joined (i.e., stitched together) to form a single continuous image are determined. During a decision step 94, a determination is made as to whether an edge of an image (i.e., an open seam) is approaching the user's viewable area. If an open seam is approaching, steps 96, 98, and 100 are performed. If an open seam is not approaching the user's viewable area, only the step 100 is performed.

During the step 96, coordinates where a copy of the current image will be placed are determined. A copy of the current image jumps to the new coordinates to allow a continuous pan during the step 98. During the step 100, both images are moved to the right to create the user perception that the user is turning to the left. Following the step 100, the look left routine 90 returns to the step 52 of FIG. 3A.

FIG. 3E is a flowchart of the look right routine 110 that allows the user to look right in the remote environment. During a step 112, coordinates of two images that must be joined at edges (i.e., stitched together) to form a single continuous image are determined. During a decision step 114, a determination is made as to whether an edge of an image (i.e., an open seam) is approaching the user's viewable area. If an open seam is approaching, steps 116, 118, and 120 are performed. If an open seam is not approaching the user's viewable area, only the step 120 is performed.

During the step 116, coordinates where a copy of the current image will be placed are determined. A copy of the current image jumps to the new coordinates to allow a continuous pan during the step 118. During the step 120, both images are moved to the right to create the user perception that the user is turning to the right. Following the step 120, the look right routine 110 returns to the step 52 of FIG. 3A.

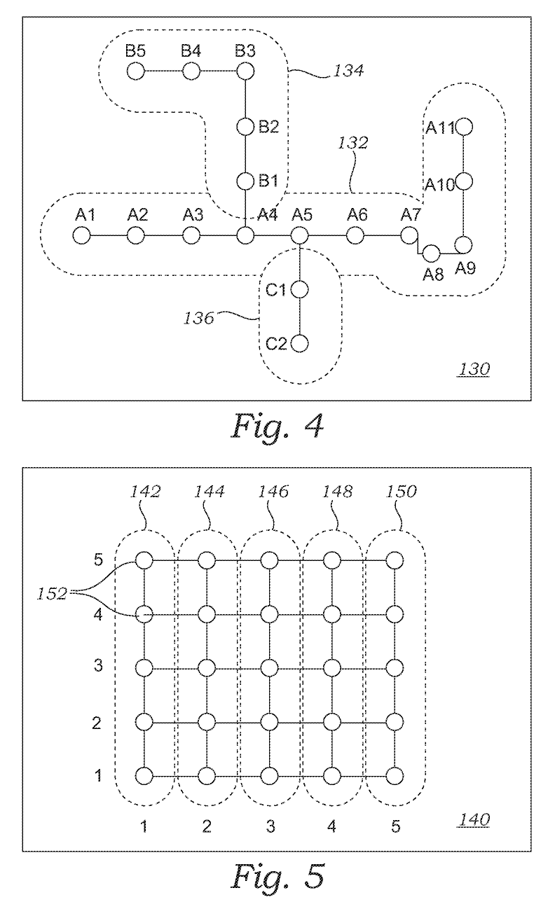

FIG. 4 is diagram depicting points along multiple paths in a remote environment 130. In FIG. 4, the paths are labeled 132, 134, and 136. A plurality of intervals or points along the paths 132, 134, and 136 are at selected intervals along the paths 132, 134, and 136. Points along the path 132 are labeled A1-A11, points along the path 134 are labeled B1-B5, and points along the path 134 are labeled C1 and C2.

A still camera (e.g., with a panoramic lens) is used to capture images at the points along the paths 132, 134, and 136. The images may be, for example, 360 degree panoramic still images, wherein each image provides a 360 degree view around the corresponding point. Alternately, the images may be pairs of 180 degree panoramic still images, wherein each pair of images provides a 360 degree view around the corresponding point. Each pair of 180 degree panoramic still images may be joined at edges (i.e., stitched together) to form a 360 degree view around the corresponding point. Further, each panoramic still image captured using a still camera with a panoramic lens is preferably subjected to a correction process wherein flaws caused by the panoramic lens are reduced.

The paths 132, 134, and 136, and the points along the paths, are selected to give the user of the computer system 10 of FIG. 1, viewing the images captured at the points along the paths 132, 134, and 136 and displayed in sequence on the display screen 20 of the display device 16, the perception that he or she is moving through, and can navigate through, the remote environment 130.

In FIG. 4, the paths 132 and 134 intersect at point A1, and the paths 132 and 136 intersect at the point A5. Points A1 and A5 are termed “intersection points.” At each intersection of the paths 132, 134, and 136, the user may continue on a current path or switch to an intersecting path. For example, when the user has navigated to the intersection point A1 along the path 132, the user may either continue along the path 132, or switch to the intersection path 134.

FIG. 5 is a diagram depicting a remote environment 140 wherein multiple parallel paths form a grid network. In FIG. 5, the paths are labeled 142, 144, 146, 148, and 150, and are oriented vertically. A plurality of intervals or points 152 along the paths 142, 144, 146, 148, and 150 are located along the vertical paths such that they coincide horizontally as shown in FIG. 5. The locations of the points 152 along the paths 142, 144, 146, 148, and 150 thus define a grid pattern, and can be identified using a coordinate system shown in FIG. 5.

As described above, a still camera (e.g., with a panoramic lens) is used to capture images at the points 152 along the paths 142, 144, 146, 148, and 150. The images may be, for example, 360 degree panoramic still images, wherein each image provides a 360 degree view around the corresponding point. Alternately, the images may be pairs of 180 degree panoramic still images, wherein each pair of images provides a 360 degree view around the corresponding point. Each pair of 180 degree panoramic still images may be joined at edges (i.e., stitched together) to form a 360 degree view around the corresponding point. Further, each panoramic still image captured using a still camera with a panoramic lens is preferably subjected to a correction process wherein flaws caused by the panoramic lens are reduced.

The paths 142, 144, 146, 148, and 150, and the points 152 along the paths, are again selected to give the user of the computer system 10 of FIG. 1, viewing the images captured at the points 152 and displayed in sequence on the display screen 20 of the display device 16, the perception that he or she is moving through, and can navigate through, the remote environment 130.

Importantly, the method preferably utilizes fewer than 150 total still images, which provide much quicker download and system response time, in comparison to larger systems that require the download or streaming of 10,000+ video images.

In FIG. 5, a number of horizontal “virtual paths” extend through horizontally adjacent members of the points 152. At each of the points 152, the user may continue vertically on a current path or move horizontally to an adjacent point along a virtual path. For example, when the user has navigated along the path 146 to a middle point located at coordinates 3-3 in FIG. 5 (where the horizontal coordinate is given first and the vertical coordinate is given last), the user may either continue vertically to one of two other points along the path 146, move to the horizontally adjacent point 2-3 along the path 144, or move to the horizontally adjacent point 4-3 along the path 148.

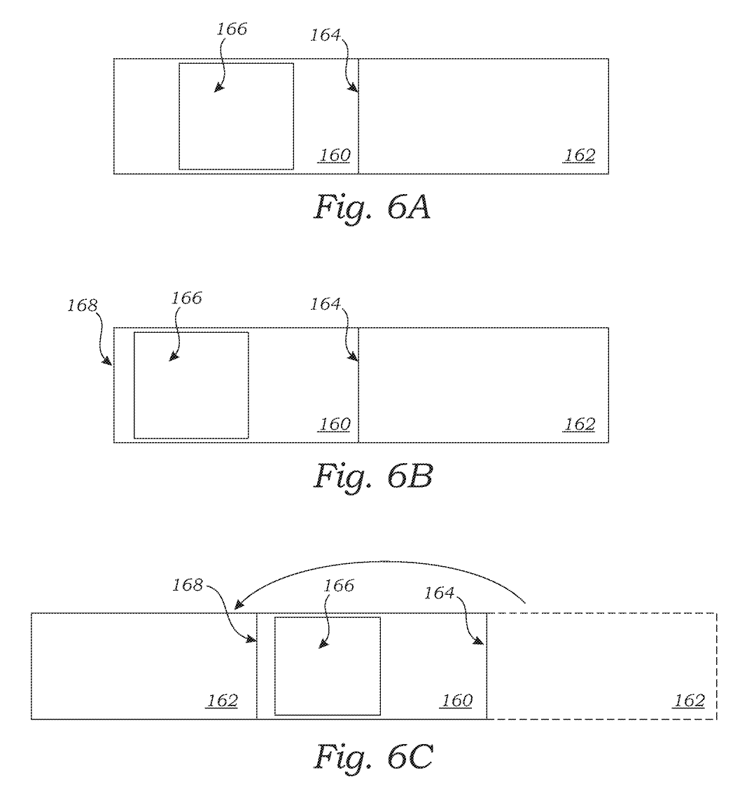

FIGS. 6A-6C illustrate a method used to join together edges (i.e., “stitch seams”) of panoramic still images such that the user of the computer system 10 of FIG. 1 has a 360 degree field of view of the remote environment. FIG. 6A is a diagram depicting two panoramic still images 160 and 162, wherein a left side edge (i.e., a seam) of the panoramic still image 162 is joined to a right side edge 164 of the panoramic still image 160. In FIG. 6A, a portion 166 of the panoramic still image 160 is currently being presented to the user of the computer system 10 of FIG. 1. In general, when the user changes his or her direction of view such that the portion 166 of the panoramic still image 160 currently being presented to the user approaches a side edge of the panoramic still image 160, a side edge of another panoramic still image is joined to the side edge of the panoramic still image 160 such that the user has a 360 degree field of view.

FIG. 6B is the diagram of FIG. 6A wherein the user of the computer system 10 of FIG. 1 has selected to look left, and the portion 166 of the panoramic still image 160 currently being presented to the user of the computer system 10 is moving to the left within the panoramic still image 160 toward a left side edge 168 of the panoramic still image 160. In FIG. 6B, the portion 166 of the panoramic still image 160 currently being presented to the user of the computer system 10 is approaching the left side edge 168 of the panoramic still image 160.

FIG. 6C is the diagram of FIG. 6C wherein in response to the portion 166 of the panoramic still image 160 currently being presented to the user of the computer system 10 approaching the left side edge 168 of the panoramic still image 160, wherein the panoramic still image 162 is moved from a right side of the panoramic still image 160 to a left side of the panoramic still image 160, and a right side edge of the panoramic still image 162 is joined to the left side edge 168 of the panoramic still image 160. In this way, should the portion 166 of the panoramic still image 160 currently being presented to the user of the computer system 10 move farther to the left an include the left side edge 168 of the panoramic still image 160, the user sees an uninterrupted view of the remote environment.

The panoramic still image 160 may advantageously be, for example, a 360 degree panoramic still image, and the panoramic still image 162 may be a copy of the panoramic still image 160. In this situation, only the two panoramic still images 160 and 162 are required to give the user of the computer system 10 of FIG. 1 a 360 degree field of view within the remote environment. The method of FIGS. 6A-6C may also be easily extended to use more than two panoramic still images each providing a visual range of less than 360 degrees.

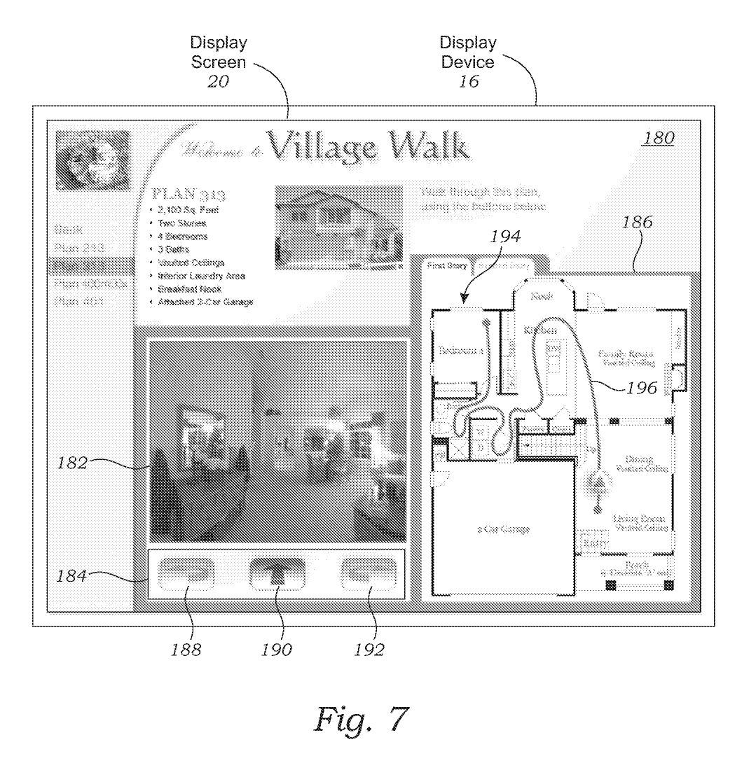

FIG. 7 shows an image 180 displayed on the display screen 20 of the display device 16 of the computer system 10 of FIG. 1. In the embodiment of FIG. 7, the remote environment is a house. The display screen 20 includes user's view portion 182, a control portion 184, and a plan view portion 186. A portion of a panoramic still image currently being presented to the user of the computer system 10 is displayed in then user's view portion 182. Selectable control images or icons are displayed in the control portion 184. In FIG. 7, the control icons includes a “look left” button 188, a “move forward” button 190, and a “look right” button 192. In general, the buttons 188, 190, and 192 are activated by the user of the computer system 10 via the input device 14 of FIG. 1. As described above, the input device 14 may be a pointing device such as a mouse, and/or a keyboard.

In FIG. 7, a plan view 194 of the remote environment and a path 196 through the remote environment are displayed in the plan view portion 186 of the display screen 20. The user moves forward along the path 196 by activating the button 190 in the control portion 184 via the input device 14 of FIG. 1. As the activates the button 190 (e.g., by pressing a mouse button while an arrow on the screen controlled by the mouse is positioned over the button 190), portions of panoramic still images are displayed sequentially in the user's view portion 182 as described above, giving the user the perception of moving along the path 196. If the user continuously activates the button 190 (e.g., by holding down the mouse button), the portions of panoramic still images are displayed sequentially such that the user experiences a perception of continuously moving along the path 196, as if walking along the path 196. As the user moves along the path 196, he or she can look to the left by activating the button 188, or look to the right by activating the button 192. The user has a 360 degree field of view at each point along the path 196.

In the embodiment of FIG. 7, the a control unit 18 of the computer system 10 of FIG. 1 is configured to display the plan view 194 of the remote environment and the path 196 in the plan view portion 186 of the display screen 20 of the display device 16. The control unit 18 is also configured to receive user input via the input device 14 of FIG. 1, wherein the user input indicates a direction of view and a desired direction of movement, and to display portions of panoramic still images in sequence in the user's view portion 182 of the display screen 20 dependent upon the user input such that the displayed images correspond to the direction of view and the desired direction of movement. As a result, when viewing the display screen 20, the user experiences a perception of movement through the remote environment in the desired direction of movement while looking in the direction of view.

In the preferred embodiment, the method further includes a step of selecting a plurality of intervals to best show the remote environment. The exact positions of the intervals can have a large impact on the effectiveness of the virtual tour. For example, each interval should clearly show as much of the remote location as possible, in the best light, and with the best overall feeling of walking through the remote environment. The selection of the intervals preferably also includes assuring that the still camera will not capture a reflection of itself when capturing the still image from the selected interval.

In the preferred embodiment, the method further includes a step of optimizing the remote environment for being photographed by the still camera from the each of the plurality of intervals. Once the intervals have been selected, small changes in the environment can enhance the images captured. For example, if there are movable mirrors in the environment, the step of optimization preferably includes moving or turning the mirrors in the remote environment so that they do not cause the still camera to capture a reflection of itself when capturing the still image from the selected interval. The optimization may also include lighting and/or adjusting lights to best show the environment, moving objects that might block or obscure a view, or any other steps that may be devised by those skilled in the art.

While the invention has been described with reference to at least one preferred embodiment, it is to be clearly understood by those skilled in the art that the invention is not limited thereto. Rather, the scope of the invention is to be interpreted only in conjunction with the appended claims.

What is claimed is:

1. A method for simulating movement of a user through a remote environment, the method comprising the steps of:
providing a still camera with a panoramic lens;
defining at least one predefined path through the remote environment;
selecting a plurality of intervals along the at least one predefined path;
positioning the still camera at each of the plurality of intervals along the at least one predefined path, and capturing a 360 degree panoramic still image using the still camera;
providing a computer system having:
a memory;
a display device having a display screen;
an input device adapted to receive user input;
storing the 360 degree panoramic still images in the memory of the computer system;
displaying a plan view of the remote environment and the at least one predefined path in a plan view portion of the display screen;
receiving input from the user via the input device, wherein the user input is indicative of a direction of view and a desired location; and
displaying portions of the 360 degree panoramic still images in a user's view portion of the display screen dependent upon the user input such that the displayed images correspond to the direction of view and the desired location.

2. The method as recited in claim 1, wherein the computer system further comprises a control unit coupled to the memory, the display device, and the input device, wherein the control unit is configured to carry out the steps of displaying the plan view of the remote environment and the at least one predefined path in the plan view portion of the display screen, receiving the user input, and displaying the portions of the 360 degree panoramic still images to the user in the user's view portion of the display screen.

3. The method as recited in claim 1, further comprising:
displaying control buttons in a control portion of the display screen, wherein the user input is generated by selecting the control buttons.

4. The method as recited in claim 3, wherein the portion of one of the 360 degree panoramic still images is displayed until one of the control buttons is selected, and the control buttons function to either change the direction of view, thereby operating to change the portion of the 360 degree panoramic still image being displayed but not which of the 360 degree panoramic still images is displayed, or change the location, thereby operating to change the location and change the 360 degree panoramic still image that is displayed to move the adjacent interval, but not to change the direction of view.

5. A method for simulating movement of a user through a remote environment, the method comprising the steps of:
providing a still camera with a panoramic lens;
defining at least one predefined path through the remote environment;
selecting a plurality of intervals along the at least one predefined path, each of the plurality of intervals being selected to clearly depict a portion of the remote environment;
optimizing the remote environment for being photographed by the still camera from the each of the plurality of intervals;
positioning the still camera at each of the plurality of intervals along the at least one predefined path, and capturing a 360 degree panoramic still image using the still camera;
providing a computer system having:
a memory;
a display device having a display screen;
an input device adapted to receive user input;
storing the 360 degree panoramic still images in the memory of the computer system;
displaying a plan view of the remote environment and the at least one predefined path in a plan view portion of the display screen;
receiving input from the user via the input device, wherein the user input is indicative of a direction of view and a desired location; and
displaying portions of the 360 degree panoramic still images in a user's view portion of the display screen dependent upon the user input such that the displayed images correspond to the direction of view and the desired location.

6. The method as recited in claim 5, wherein the computer system further comprises a control unit coupled to the memory, the display device, and the input device, wherein the control unit is configured to carry out the steps of displaying the plan view of the remote environment and the at least one predefined path in the plan view portion of the display screen, receiving the user input, and displaying the portions of the 360 degree panoramic still images to the user in the user's view portion of the display screen.

7. The method as recited in claim 5, further comprising:
displaying control buttons in a control portion of the display screen, wherein the user input is generated by selecting the control buttons.

8. The method as recited in claim 5, wherein the step of optimizing the remote environment for being photographed by the still camera from the each of the plurality of intervals includes moving or turning any mirrors in the remote environment so that they do not cause the still camera to capture a reflection of itself when capturing the still image from the selected interval.

9. The method as recited in claim 5, wherein the step of selecting a plurality of intervals includes assuring that the still camera will not capture a reflection of itself when capturing the still image from the selected interval.

10. A method for simulating movement of a user through a compact remote environment, the method comprising the steps of:
providing a still camera with a panoramic lens;
defining at least one predefined path through the remote environment;
selecting a plurality of intervals along the at least one predefined path;
positioning the still camera at each of the plurality of intervals along the at least one predefined path, and capturing a 360 degree panoramic still image using the still camera;
providing a computer system having:
a memory;
a display device having a display screen;
an input device adapted to receive user input;
storing fewer than 150 of the 360 degree panoramic still images in the memory of the computer system, the fewer than 150 of the 360 degree panoramic still images together providing a virtual model of the compact remote environment;
displaying a plan view of the remote environment and the at least one predefined path in a plan view portion of the display screen;
receiving input from the user via the input device, wherein the user input is indicative of a direction of view and a desired location; and
displaying portions of the 360 degree panoramic still images in a user's view portion of the display screen dependent upon the user input such that the displayed images correspond to the direction of view and the desired location.
